(19) United States
(12) Patent Application Publication
(10) Pub. No.: US 2023/0144583 A1
(43) Pub. Date: May 11, 2023

(54) PROCESSES FOR PREPARING SUSPENSION CONCENTRATE FORMULATIONS COMPRISING PESTICIDAL MIXTURES

(71) Applicant: FMC Corporation, Philadelphia, PA (US)

(72) Inventor: Guozhi Wang, Oakland Gardens, NJ (US)

(21) Appl. No.: 17/912,235

(22) PCT Filed: Mar. 17, 2021
(86) PCT No.: PCT/US2021/022737

§ 371 Date: Sep. 16, 2022

Related U.S. Application Data
(60) Provisional application No. 62/990,519, filed on Mar. 17, 2020.

(51) Int. Cl. A01N 53/00; A01N 25/04; A01N 25/22; A01N 43/56; A01N 47/38; A01N 43/50; A01P 7/04

(52) U.S. Cl. CPC A01N 53/00; A01N 25/04; A01N 25/22; A01N 43/56; A01N 47/38; A01N 43/50; A01P 7/04

(57) ABSTRACT

Described herein are processes for preparing aqueous suspensions of organic pesticides. The processes include inducing crystallization of an amorphous organic pesticide with a crystalline organic pesticide where the crystalline organic pesticide and amorphous organic pesticide are not identical. Also described herein are aqueous pesticide formulations including the prepared aqueous suspensions.

### CROSS-REFERENCE TO RELATED APPLICATIONS

This application claims the benefit of U.S. Provisional Application No. 62/990,519 filed Mar. 17, 2020.

### FIELD OF DISCLOSURE

This disclosure is directed to processes for preparing aqueous suspension concentrates of organic pesticides. The processes include inducing crystallization of an amorphous organic pesticide with a crystalline organic pesticide where the crystalline organic pesticide and amorphous organic pesticide are not identical.

### BACKGROUND

Suspension concentration (SC) formulations comprise solid active ingredients dispersed in water. SCs have gained popularity because of their numerous benefits, including ease of use and effectiveness, elimination of dust, and elimination of solvent hazards when compared to formulation types such as emulsifiable concentrate (EC) and wettable powder (WP) formulations.

Typically, SCs are prepared by milling crystalline active ingredient, such as crystalline bifenthrin, or using crystalline bifenthrin to induce crystallization of amophorous bifenthrin. However, these typical processes can result in toxic and/or explosive dust produced by the dry active ingredient.

The present disclosure is based on the surprising finding that a crystalline organic pesticide can be used to seed crystallization of an amorphous organic pesticide where the crystalline organic pesticide and amorphous organic pesticide are not identical. Advantages of the present processes include avoiding toxic and explosive crystalline pesticidal dust such as crystalline Bifenthrin and thereby reducing worker's exposure as well as reducing dust explosion potential.

The processes described herein allow for the preparation of aqueous suspensions of organic pesticides, as well as aqueous pesticide formulations including the prepared aqueous suspensions, by using a first active ingredient with a relatively high melting point to induce crystallization of a second active ingredient with a relatively low melting point. These processes are broadly applicable to formulations including two or more different active ingredients with aforementioned physical properties.

### BRIEF DESCRIPTION

In one aspect, provided herein is a process of preparing an aqueous suspension of organic pesticides, the process comprising

I) forming a mixture comprising
A) a formulation additive; and
B) at least one crystalline organic pesticide;

II) adding at least one amorphous organic pesticide to the mixture under conditions of agitation or emulsification;

II) crystallizing the at least one amorphous organic pesticide;

IV) optionally filtering the mixture;

V) optionally drying the mixture; and

VI) optionally milling the mixture;

wherein the at least one amorphous organic pesticide is not identical to the at least one crystalline organic pesticide.

In one aspect, provided herein is a process of preparing an aqueous suspension of organic pesticides, the process comprising

I) forming a mixture comprising a formulation additive;

II) adding at least one amorphous organic pesticide to the mixture under conditions of agitation or emulsification;

III) adding at least one crystalline organic pesticide to the mixture;

IV) crystallizing the at least one amorphous organic pesticide;

V) optionally filtering the mixture;

VI) optionally drying the mixture; and

VII) optionally milling the mixture;

wherein the at least one amorphous organic pesticide is not identical to the at least one crystalline organic pesticide.

### DETAILED DESCRIPTION OF THE DISCLOSURE

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where an disclosure or a portion thereof is defined with an open-ended term such as “comprising,” it should be readily understood that (unless otherwise stated) the description should be interpreted to also describe such an disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and 13 is false (or not present), A is false (or not present) and 13 is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

It also is understood that any numerical range recited herein includes all values from the lower value to the upper value. For example, if a weight ratio range is stated as 1:50, it is intended that values such as 2:40, 10:30, or 1:3, etc., are expressly enumerated in this specification. These are only examples of what is specifically intended, and all possible combinations of numerical values between and including the lowest value and the highest value enumerated are to be considered to be expressly stated in this application.

As used herein, the term “about” means plus or minus 10% of the value.

“Crystalline” in terms of the present invention means that at least 90% by weight of the pesticide compound, which is present in the aqueous suspension, is in the crystalline state and that less than 10% by weight of the pesticide compound, which is present in the aqueous suspension, is not crystalline, i.e. amorphous. The degree of crystallinity can be simply determined by powder X-ray diffraction (powder XRD) of the pesticide compound, by optical microscopy (due to birefringence of the crystalline phase), in most cases also from DSC analysis (DSC=differential scanning calorimetry), and in some cases by IR spectrometry.

“Amorphous” in terms of the present invention means that the pesticide compound, which is present in the aqueous emulsion, is essentially not crystalline, i.e. it contains less than 10% by weight, based on the total amount of the pesticide compound, or no traceable amounts of crystalline material. Amorphous forms include liquids forms, i.e. melt and supercooled melt, solution in water miscible solvent, and solid amorphous forms.

In one embodiment, the amorphous organic pesticide has a relatively low melting point. In one embodiment, the amorphous organic pesticide has a melting point in the range of about 40° C. to about 80° C. In another embodiment, the amorphous organic pesticide has a melting point in the range of about 40° C. to about 70° C.

In one embodiment, the amorphous organic pesticide has a relatively low solubility in water. In one embodiment, the amorphous organic pesticide has a solubility in water of less than about 2 mg/L at 20° C. In another embodiment, the amorphous organic pesticide has a solubility in water of less than about 10 Ig/L at 20° C.

In one embodiment, the amorphous organic pesticide is in a form selected from a melt, a supercooled melt, a solid amorphous form, a liquid, a solution comprising an active ingredient and a water miscible solvent, and combinations thereof.

In one embodiment, the amorphous organic pesticide is selected from bifenthrin, gamma-cyhalothrin, lambda-cyhalothrin, pyraclostrobin, chlorpyrifos, and combinations thereof.

In one embodiment, the crystalline organic pesticide has a relatively high melting point. In one embodiment, the crystalline organic pesticide has a melting point greater than about 60° C. In one embodiment, the crystalline organic pesticide has a melting point greater than about 65° C. In another embodiment, the crystalline organic pesticide has a melting point greater than about 80° C.

In one embodiment, the crystalline organic pesticide can have a relatively high solubility in water. In one embodiment, the crystalline organic pesticide has a solubility in water of less than 2 g/L at 20° C. In another embodiment, the crystalline organic pesticide has a solubility in water of less than 600 mg/L at 20° C. In another embodiment, the crystalline organic pesticide has a solubility in water of less than 150 mg/L at 20° C. In another embodiment, the crystalline organic pesticide has a solubility in water of less than 1 mg/L at 20° C.

In one embodiment, the crystalline organic pesticide is selected from insecticides, fungicides, nematicides, and combinations thereof. In one embodiment, the crystalline organic pesticide is selected from chlorantraniliprole, cyantraniliprole, flutriafol, indoxacarb, imidacloprid, fluindapyr and combinations thereof.

In one embodiment, an amorphous organic pesticide is added to a mixture containing a formulation additive at elevated temperature. In one embodiment, an amorphous organic pesticide is added to a mixture at a temperature that is above the melting point of the amorphous organic pesticide and below the melting point of the crystalline organic pesticide. In one embodiment, an amorphous organic pesticide is added to a mixture at a temperature that is below the melting point of the amorphous organic pesticide and below the melting point of the crystalline organic pesticide. In one embodiment, an amorphous organic pesticide is added to a mixture in a process step at a temperature in the range of about 20° C. to about 100° C. In another embodiment, an amorphous organic pesticide is added to a mixture in a process step at a temperature in the range of about 30° C. to about 65° C.

In one embodiment, the suspension concentrate formulations may be milled to desired particle sizes. In one embodiment, the suspension concentrate formulations may be milled to particle sizes of about 0.5 μm to about 20 μm. In another embodiment, the suspension concentrate formulations may be milled to particle sizes of about 1 μm to about 10 μm.

In one embodiment, the suspension concentrate formulations are filtered and dried before milling. In one embodiment, the suspension concentrate formulations are filtered before milling. In one embodiment, the suspension concentrate formulations are dried before milling.

In one embodiment, the process step of milling the mixture occurs with a device selected from attritor mills, bead mills, colloid mills, rotor-stators, jet mills, air classifying mills, ring mills, hammer mills, pin mills, puck mills, and combinations thereof. In another embodiment, the process step of milling the mixture occurs with a mill selected from ring mills, bead mills, attritor mills, jet mills, air classifying mills, and combinations thereof.

In one embodiment, the suspension concentrate formulation is formed in a mix vessel before being transferred to a milling device. In one embodiment, the suspension concentrate formulation is formed in a milling device. In one embodiment, the suspension concentrate formulation is transferred to a holding tank after milling in a milling device. In one embodiment, the suspension concentrate formulation is prepared in a continuous process.

In one embodiment, the amorphous organic pesticide is crystallized in a process step that includes mixing a mixture containing a formulation additive and a crystalline organic pesticide and optionally cooling the mixture.

In one embodiment, the formulation additive is selected from water, anti-freeze agents, viscosity-modifying agents, antifoamns, bactericides, surfactants, and combinations thereof.

In one embodiment, an aqueous pesticide formulation may be prepared by adding an additive to an aqueous suspension produced according to the present disclosure. In one embodiment, the additive is selected from water, anti-freeze agents, viscosity-modifying agents, antifoams, bactericides, surfactants, and combinations thereof.

In one embodiment, water is used to dilute the suspension concentrate compositions to provide spray mixtures that can be used according to the disclosure. The concentration of active compound in the spray mixtures of the disclosure can be varied within a certain range. In general, the concentration of active compound is from about 0.0003 to about 5 percent by weight, in one embodiment from about 0.003 to about 3 percent by weight, and in another embodiment from about 0.01 to about 0.06 percent by weight.

To prepare aqueous spray mixtures that are ready for application, the concentrated formulation can be mixed with a quantity of water, with stirring and/or pumping if necessary to uniformly distribute the formulation in the water.

Conventional mixing apparatus and/or spray equipment suitable for the purpose can be employed for the preparation and application of the spray mixtures of the disclosure.

In one embodiment, the suspension concentrate formulation further comprises an additional pesticidal active ingredient selected from abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos methyl, benfuracarb, bensultap, benzpyrimoxan, bifenthrin, kappa-bifenthrin, bifenazate, bistrifluron, borate, broflanilide, buprofezin, cadusafos, carbaryl, carbofiuran, cartap, carzol, chlorantraniliprole, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cyantraniliprole, (3-bromo-1-(3-chiro-2-pyridinyl)-N-[4-cyano-2-methyl-6-[(methylamino)carbonyl]phenyl]-1H-pyrazole-5-carboxamide), cyclaniliprole (3-bromo-N-[2-bromo-4-chloro-6-[[(1-cyclopropylethyl)amino]carbonyl]phenyl]-1-(3-chloro-2-pyridinyl)-1H-pyrazole-5-carboxamide), cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, beta cyfluthrin, cyhalodiamide, cyhalothrin, gamma-cyhalothrin, lambda-cyhalothrin, cypermethrin, alpha-cyperrnethrin, zeta-cypermethrin, cyronazine, deltamethrin, diafenthiuron, diazinon, dicloromezotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metotluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(tritluoromethoxy)phenoxy]-4-quinolinyl methyl carbonate), flonicamid, fluazaindolizine, flubendiamide, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), flubexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethyleyclopropanecarboxylate), nicotine, nitenpyram, nithiazine, novaluron, noviflumuron, N-[1,1-dimethyl-2-(methylthio)ethyl]-7-fluoro-2-(3-pyridinyl)-2H-indazole-4-carboxamide, N-[1,1-dimethyl-2-(methylsulfanyl)ethyl]-7-fluoro-2-(3-pyridinyl)-2H-indazole-4-carboxamide, N-1,1-dimethyl-2-(methylsulfonyl)ethyl]-7-fluoro-2-(3-pyridinyl)-2H-indazole-4-carboxamide, N-(1-methylcyclopropyl)-2-(3-pyridinyl)-2H-indazole-4-carboxamide, and N-[1-(difluoromethyl)cyclopropyl]-2-(3-pyridinyl)-2H-indazole-4-carboxamide, oxamyl, oxazosulfyl, parathion, parathion methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-(1-(methoxymethylene)benzeneacetate), pydiflumetofen, pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ4-sulfanylidene]cyanamide), tebufenozide, tebufenpyrad, teflubenzuron, tefluthrin, kappa-tefluthrin, terbufos, tetrachlorantraniliprole, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), tetraniliprole, thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuiron, tyclopyrazoflor, zeta-cypermethrin, Bacillus thuringiensis delta-endotoxins, entomopathogenic bacteria, entomopathogenic viruses, entomopathogenic fungi, and combinations thereof.

The compositions produced according to the present disclosure may optionally include one or more pest control agents selected from insecticides, herbicides, biopesticides, nematicides, bactericides, and fungicides. General references for these pest control agents (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U.K., 2003 and The BioPesticide Manual, 2^{nd} Edition, L G. Copping, Ed., British Crop Protection Council, Farnham, Surrey, U. K., 2001.

Non-limiting examples of insecticides include abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphosmethyl, benfuracarb, bensultap, benzpyrimoxan, bifenthrin, kappa-bifenthrin, bifenazate, bistritluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, betacyfluthrin, cyhalothrin, gamma-cyhalothrin, lambda-cyhalothrin, cypermethrin, alpha-cyperrnethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, fluferoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, taufluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, N-[1,1-dimethyl-2-(methylthio)ethyl]-7-fluoro-2-(3-pyridinyl)-2H-indazole-4-carboxamide, N-[1,1-dimethyl-2-(methylsulfinyl)ethyl]-7-fluoro-2-(3-pyridinyl)-2H-indazole-4-carboxamide, N-[1,1-dimethyl-2-(methylsulfonyl)ethyl]-7-fluoro-2-(3-pyridinyl)-2H-indazole-4-carboxamide, N-(1-methylcyclopropyl)-2-(3-pyridinyl)-2H-indazole-4-carboxamide, N-[1-(difluoromethyl)cyclopropyl]-2-(3-pyridinyl)-2H-indazole-4-carboxamide, oxamyl, oxazosulfyl, parathion, parathionmethyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (cE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-)⁴-sulfanylidene]cyanramide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxynethyl)phenyl]rnethyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazarnate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entornopathogenic fungi, can combinations thereof.

Non-limiting examples of fungicides include fungicides such as acibenzolar-S-methyl, aldimorph, ametoctradin, aminopyrifen, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, carboxin, carpropamid, captafol, captan, carbendazim, chloroneb, chlorothalonil, chlozolinate, copper hydroxide, copper oxychloride, copper sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethirimol, dimethomorph, dimoxystrobin, diniconazole (including diniconazoleM), dinocap, dipymetitrone, dithianon, dithiolanes, dodemorph, dodine, econazole, etaconazole, edifenphos, enoxastrobin (also known as enestroburin), epoxiconazole, ethaboxam, ethirimol, etridiazole, famoxadone, fenamidone, fenaminstrobin, fenarimol, fenbuconazole, fenfuram, fenhexamide, fenoxanil, fenpiclonil, fenpicoxamid, fenpropidin, fenpropimorph, fenpyrazamine, fentin acetate, fentin hydroxide, ferbam, ferimzone, flometoquin, florylpicoxamid, fluopimomide, fluazinam, fludioxonil, flufenoxystrobin, fluindapyr, flumorph, fluopicolide, fluopyram, fluoxapiprolin, fluoxastrobin, fluquinconazole, flusilazole, flusulfamide, flutianil, flutolanil, flutriafol, fluxapyroxad, folpet, fthalide (also known as phthalide), fuberidazole, furalaxyl, furametpyr, hexaconazole, hymexazole, guazatine, imazalil, imibenconazole, iminoctadine albesilate, iminoctadine triacetate, inpyrfluxam, iodicarb, ipconazole, ipfentrifluconazole, ipflufenoquin, isofetamid, iprobenfos, iprodione, iprovalicarb, isoflucypram, isoprothiolane, isopyrazam, isotianil, kasugamycin, kresoxim-methyl, lancotrione, mancozeb, mandipropamid, mandestrobin, maneb, mapanipyrin, mefentrifluconazole, mepronil, meptyldinocap, metalaxyl (including metalaxyl-M/mefenoxam), metconazole, methasulfocarb, metiram, metominostrobin, metyltetraprole, metrafenone, myclobutanil, naftitine, neo-asozin (ferric methanearsonate), nuarimol, octhilinone, ofurace, orysastrobin, oxadixyl, oxathiapiprolin, oxolinic acid, oxpoconazole, oxycarboxin, oxytetracycline, penconazole, pencycuron, penflufen, penthiopyrad, perfurazoate, phosphorous acid (including salts thereof, e.g., fosetyl-aluminm), picoxystrobin, piperalin, polyoxin, probenazole, prochloraz, procymidone, propamocarb, propiconazole, propineb, proquinazid, prothiocarb, prothioconazole, pydiflumetofen (Adepidyn®), pyraclostrobin, pyrametostrobin, pyrapropoyne, pyraoxystrobin, pyraziflumid, pyrazophos, pyribencarb, pyributacarb, pyridachlometyl, pyrifenox, pyriofenone, perisoxazole, pyrimethanil, pyrifenox, pyrrolnitrin, pyroquilon, quinconazole, quinmethionate, quinofumelin, quinoxyfen, quintozene, silthiofam, sedaxane, simeconazole, spiroxamine, streptomycin, sulfur, tebuconazole, tebufloquin, teclofthalam, tecloftalam, teenazene, terbinafine, tetraconazole, thiabendazole, thifluzamide, thiophanate, thiophanate-methyl, thiram, tiadinil, tolclofos-methyl, tolprocarb, tolyfluanid, triadimefon, triadimenol, triarimol, triazoxide, tribasic copper sulfate, triclopyricarb, tridemorph, trifloxystrobin, triflumizole, trimoprhamide tricyclazole, trifloxystrobin, triforine, triticonazole, uniconazole, validamycin, valifenalate (also known as valifenal), vinclozolin, zineb, ziram, zoxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, and combinations thereof.

Non-limiting examples of nematocides include fluopyram, spirotetramat, thiodicarb, fosthiazate, abamectin, iprodione, fluensulfone, dimethyl disulfide, tioxazafen, 1,3-dichloropropene (1,3-D), metam (sodium and potassium), dazomet, chloropicrin, fenamiphos, ethoprophos, cadusaphos, terbufos, imicyafos, oxamyl, carbofuran, tioxazafen, Bacillus firmus, Pasteuria nishizawae, and combinations thereof. A non-limiting example of a bactericide is streptomycin. Non-limiting examples of acaricides include amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, and combinations thereof.

Phytophagous Insects

Phytophagous insects refers to invertebrate pests causing injury to plants by feeding upon them, such as by eating foliage, stem, leaf, fruit or seed tissue or by sticking the vascular juices of plants. Leaf feeders may be external (exophytic) or they may mine the tissues, sometimes even specializing on a particular cell type. There are phytophagous insect species in the majority of insect orders, including Hemiptera, Thysanoptera, Orthoptera, Lepidoptera, Coleoptera, Heteroptera, Hymenoptera, and Diptera.

Examples of agronomic or nonagronomic invertebrate pests include eggs, larvae and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), beet armyworm (Spodoptera exigua Hübner), cotton leafworm (Spodoptera littoralis Boisduval), yellowstriped armyworm (Spodoptera ornithogalli Guende), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Cranbus caliginosellus Clemens), sod webworms (Pyralidae: Cranbinae) such as sod worm (Herpetogramma licarsisalis Walker), sugarcane stem borer (Chilo infuscatellus Snellen), tomato small borer (Neoleucinodes elegantalis Guenée), green leafroller (Cnaphalocrocis medinalis), grape leaffolder (Desmia funeralis Hübner), melon worm (Diaphania nitidalis Stoll), cabbage center grub (Helluala hydralis Guenée), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis English)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck), citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia anbiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamond back moth (Plutella xylostella Linnaeus), pink bollworm (Pectinophora gossypiella Saunders), gypsy moth (Lymantria dispar Linnaeus), peach fruit borer (Carposina niponensis Walsingham), peach twig borer (Anarsia lineatella Zeller), potato tuberworm (Phthorimaea operculella Zeller), spotted teniform leafminer (Lithacoletis blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella gernanica Linnaeus), brownbanded cockroach (Supella longila Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidae, Bruchidae, and Curculionidae (e.g., boll weevil (Anthonomus grandis Boheman), rice water weevil (Lissorhoptrws oryzophilus Kuschel), granary weevil (Sitophilw granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus), Denverbillbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scarabaeidae (e.g., Japanese beetle (Popillia japonica Newman), oriental beetle (Anomala orientalis Waterhouse, Exomala orientalis (Waterhouse) Baraud), northern masked chafer (Cytclcephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowvsky)); carpet beetles from the family Dermestidae; wireworms from the family Elateridae; bark beetles from the family Scolytidae and flour beetles from the family Tenebrionidae.

In addition, agronomic and nonagronomic pests include: eggs, adults and larvae of the order Dermaptera including earwigs from the family Forficulidae (e.g., European earwig (Forficula auricularia Linnaeus), black earwig (Chelisoches morio Fabricius)); eggs, immatures, adults and nymphs of the orders Hemiptera and Homoptera such as, plant bugs from the family Miridae, cicadas from the family Cicadidae, leafhoppers (e.g. Empoasca spp.) from the family Cicadellidae, potato leafhoppers, bed bugs (e.g., Cimex lectularius Linnaeus) from the family Cimicidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, chinch bugs (e.g., hairy chinch bug (Blissus leucopterus hirtus Montandon) and southern chinch bug (Blissus insularis Barber)) and other seed bugs from the family Lygaeidae, spittlebugs from the family Cercopidae squash bugs from the family Coreidae, and red bugs and cotton stainers from the family Pyrrhocoridae.

Agronomic and nonagronomic pests also include: eggs, larvae, nymphs and adults of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodicidae, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and ticks in the family Argasidae, commonly known as soft ticks (e.g., relapsing fever tick (Ornithodoros turicata), common fowl tick (Argas radiatus)); scab and itch mites in the families Psoroptidae, Pyemotidae, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borelii Giglio-Tos)); eggs, adults and immatures of the order Diptera including leafminers (e.g., Liriomyza spp. such as serpentine vegetable leafminer (Liriomyza sativae Blanchard)), midges, fruit flies (Tephritidae), frit flies (e.g., Oscinella frit Linnacus), soil maggots, house flies (e.g., Musca domestica Linnaeus), lesser house flies (e.g., Fannia canicularis Linnaeus, F. jemoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus penisylvanricus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrctermes sp., Odontotermes obesus Rambur), Kalotermitidae (e.g., Cryptotermes sp.), and Rhinotermitidae (e.g., Reticulitermes sp., Coptolerines sp., Heterotermes tenuis Hagen) families, the eastern subterranean termite (Reticuliternes flavipes Kollar), western subterranean termite (Reticulitermes hesperus Banks), Formosan subterranean ternite (Coptotermes fornmosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinaeca Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus), lesser grain borer (Rhyzopertha dominica), rice weevil (Stiophilus oryzae), maize weevil (Stiophilus zeamais), cowpea weevil (Callosobruchus maculatus), red flour beetle (Tribolium castaneum), granary weevil (Stiophilus granarius), Indian meal moth (Plodia interpunctella), Mediterranean flour beetle (Ephestia kuhniella) and flat or rusty grain beetle (Cryptolestis ferrugineus).

Compositions produced according to the present disclosure may have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundwonns, such as Strongylus vulgaris in horses, Toxocara canis in dogs, Haemonchus centertus in sheep, Dirofilaria immitis Leidy in dogs, Anoplocephala perfoliata in horses, Fasciola hepatica Linnaeus in ruminants, etc.).

Compositions produced according to the disclosure may have activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guende (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vitella Fabricius (spotted bollworm), Helicoverpa armigera Hûbner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophera gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamond back moth), Spodoptera exigua Hübner (beet armyworm), Spedoptera litura Fabricius (tobacco cutworm, cluster caterpillar), Spodoptera frugiperda J. E. Smith (fall armyworm), Trichoplusia ni Hübner (cabbage looper) and Tuta abseluta Meyrick (tomato leafminer)).

Compositions produced according to the disclosure may have significant activity on members from the order Homoptera including: Acyrthosiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjunov/Mordvilko (Russian wheat aphid), Dysaphis plantaginea Paaserini (rosy apple aphid), Eriosona lanigerum Hausmann (woolly apple aphid), Hyalopterus pruni Geoffroy (mealy plum aphid), Lipaphis erysini Kaltenbach (turnip aphid), Metopolophiun dirrhodum Walker (cereal aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci (Gennadius (tobacco whitefly, sweetpotato whitefly), Benisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leathopper), Nephotettix cinticeps Uhler (green leafhopper), Nephotettix nigropictus St\dot{a}l (rice leafhopper), Nilaparvata lugens St\dot{a}l (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leathoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions produced according to this disclosure also may have activity on members from the order Hemiptera including: Acrosternum hilare Say (green stink bug), Anasa tristis De Geer (squash bug), Blissus leucopterus Say (chinch bug), Cimex lectularius Linnaeus (bed bug) Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Halyrnorpha halys St\dot{A}l (brown marrnorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrips), Scirthothrips citri Moulton (citrus thrips), Sericothrips variabilis Beach (soybean thrips), and Thrips tabaci Lindeman (onion thrips); and the order Coleoptera (e.g., Lepuinotarsa decemlineata Say (Colorado potato beetle), Epilachna varivestis Mulsant (Mexican bean beetle) and wireworms of the genera Agriotes, Athous or Limonius).

In some aspects, the compositions produced according to the disclosure are useful for controlling Western Flower Thrips (Frankliniella occidentalis). In some aspects, the compositions produced according to the disclosure are useful for controlling potato leafhopper (Empoasca fabae). In some aspects, the compositions produced according to the disclosure are useful for controlling cotton melon aphid (Aphis gossypii). In some aspects, the compositions produced according to the disclosure are useful for controlling diamond backmoth (Plutella xylostella L.). In some aspects, the compositions produced according to the disclosure are useful for controlling Silverleaf Whitefly (Bemisia argentifolii Bellows & Perring).

In cyantraniliprole aspects of the disclosure, the compositions produced according to the disclosure are effective against Coleoptera, Chrysomelidae, Cerotoma trifurcata bean leaf beetle, Chaetocnema concinna beet flea beetle, Epilachna varivestis Mexican bean beetle, Epitrix cucumeris potato flea beetle, Leptinotarsa decemlineata Colorado potato beetle, Oulema melanopus cereal leaf beetle, Oulema oryzae rice leaf beetle, Phyllotreta cruciiferae cabbage flea beetle, Phyllotreta striolata striped flea beetle, Psylliodes spp. flea beetles, Curculionidae, Anthonomus eugenii pepper weevil, Ceutorhynchus napi cabbage stem weevil, Ceutorhynchus quadridens cabbage seed-stalk curculio, Conotrachelus nenuphar plum curculio, Hypera bruneipennis Egyptian alfalfa weevil, Hypera postica alfalfa weevil, Lissorhoptrus oryzophilus rice water weevil, Nitidulidae, Meligethes aeneus pollen beetle, blossom beetle, Scarabaeidae, Cotinis nitida green June beetle, Phyllophaga spp. June beetles, grubs, Popillia japonica Japanese beetle, Diptera, Agromyzidae, Liromyza chinensis stone leek leafminer, Liromyza huidobrensis pea leafminer, Liriomyza sativae serpentine/vegetable leafminer, Liromyza trifolii American serpentine leafminer, Anthomyiidae, Delia antiqua onion fly, Delia platura seedcorn maggot, Muscidae, Atherigona oryzae rice seedling fly, Psilidae, Psila rosae carrot fly, Tephritidae, Anastrepha fraterculus South American fruit fly, Anastrepha ludens Mexican fruit fly, Anasterpha striata guava fruit fly, Bactrocera cucurbitae melon fly, Bactrocera dorsalis oriental fruit fly, Bactrocera oleae olive fly, Ceratitis capitata Mediterranean fruit fly, Chromatomyia horticola garden pea leafminer, Rhagoletis cerasi cherry fruit fly, Rhagoletis cingulata cherry fruit fly, Rhagoletis indifferens western cherry fruit fly, Rhagoletis pomonella apple maggot, Hemiptera, Aleyrodidae, Aleyrodes proletella cabbage whitefly, Bemisia tabaci sweet potato whitefly, cotton whitefly, Dialeurodes citri citrus whitefly, Trialeurodes vaporariorum, greenhouse whitefly, Aphididae, Acyrthosiphon pisum pea aphid, Aphis craccivora cowpea aphid, Aphis fabae black bean aphid, Aphis glycines soybean aphid, Aphis gossypii cotton aphid, melon aphid, Aphis nasturtii buckthorn aphid, Aphis pomi green apple aphid, Aphis spiraceola spirea aphid, Aulacorthum solani foxglove aphid, Brachycaudus persicae black peach aphid, Brevicoryne brassicae cabbage aphid, Chromaphis juglandicola European walnut aphid, Dysaphis plantaginea rosy apple aphid, Hyalopterus pruni mealy plum aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Rhopalosiphum nymphaeae plum aphid, Schizaphis graminum greenbug, Sitobion avenae English grain aphid, Therioaphis maculata spotted alfalfa aphid, Toxoptera citricida brown citrus aphid, oriental citrus aphid, Cicadellidae, Empoasca fabae leathopper/jassid complex, Empoasca vitis green frogfly, Hortensia similis common green leafhopper, Idioscopus spp. mango leafhopper, Jacobiasca lybica cotton jassid, Nephotettix spp. rice green leafhopper complex, Typhlocyba rosae rose leafhopper, Typhlocyba pomaria white apple leafhopper, Coreidae Leptocorisa oratorius rice bug, rice ear bug, paddy bug, Delphacidae, Nilaparvata lugens rice brown planthopper, Diaspididae, Aonidiella aurantii citrus scale, Flatidae, Metcalfa pruinosa citrus flatid planthopper, Pentatomidae, Euschistus spp. brown stinkbugs, Edessa spp. stink bugs, Psyllidae, Diaphorina citri Asian citrus psyllid, Paratrioza cockerelli potato psyllid, tomato psyllid, Trioza eugeniae eugenia psyllid, lillypilly psyllid, Hymenoptera Tenthredinidae, Hoplocampa testudinea European apple sawfly, Lepidoptera, Crambidae, Scirpophaga incertulas yellow (rice) stemborer, Celechiidae, Anarsia lineatella peach twig borer, Keiferia lycopersicella tomato pinworm, Pectinophora gossypiella pink bollworm, Tuta absoluta tomato leafminer, Gracillariidae, Gracillaria theivora tea leafroller, Phyllonorycter blancardella spotted tentiform leafminer, Phyllonorycter coryfoliella nut leaf blister moth, Phyllonorycter crataegella apple blotch leafminer, Phyllonorycter ringoniella apple leafminer, Phyllonorycter elmaella western tentiform leafminer, Hesperiidae, Borbo cinara rice leafroller, Lyonetiidae, Leucoptera coffeella white coffee leafminer, Leucoptera scitella pear leaf blister moth, Lyonetia clerkella peach, leaf miner, Noctuidae, Agrotis segetum common cutworm, Alabama argillacea cotton leafworn, Autographa californica alfalfa looper, Barathra brassicae cabbage armyworm, Chrysodeixis chalcites green garden looper, Chrysodeixis eriosoma green semi-looper, Earias insulana Egyptian bollworm, Earias vittella northern rough bollworm, Feltia subterranea granulate cutworm, Helicoverpa armigera American bollworm, cotton bollworm, Helicoverpa punctigera climbing cutworm, Heliothis virescens tobacco budworm, Helicoverpa zea corn earworm, Prodenia ornithogalli yellow-striped armyworm, Pseudaletia unipuncta true armyworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistidae, Phylloenistis citrella citrus leafminer, Pieridae, Colias eurytheme alfalfa caterpillar, Leptophobia aripa green-eyed white, Pieris brassicae cabbage butterfly, large white, Pieris rapae imported cabbage worm, cabbage white, Plutellidae, Plutella xylostella diamondback moth, Pyralidae, Chilo suppressalis Asiatic rice stemborer, Cnaphalocerus medinalis rice leaffolder, Crocidolomia binotalis cabbage caterpillar, Desmia fumeralis grape leaffolder, Diaphania indica cotton caterpillar, Diaphania nitidaltis melonworm, Hellula hydralis cabbage center grub, Hellula undalis cabbage webworm, Lerodea eufala rice leaffolder, Leucinodes orbonalis brinjal fruit borer, Maruca testulalis bean pod borer, Neoleucinodes elegantalis small tomato borer, Nymphula depunctalis rice caseworm, Ostrinia furnicalis Asian corn borer, Ostrinia nubilalis European corn borer, Sphingidae, Manduca sexta tomato hornworm, tobacco hornworm, Smerinthus spp. sphinx moths, Tortricidae, Adoxophyes orana summer fruit tortrix, Argyrotaenia pulchellana grape tortrix, Argyrotaenia velutinana red-banded leafroller, Choristoneura rosaceana oblique-banded leafroller, Eupoecilia ambiguella grape berry moth, Cydia pomonella codling moth, Cydia prunivora lesser apple worm, Grapholita molesta oriental fruit moth, Lobesia botrana grape vine moth, Pandemis heparana apple brown tortrix, Pandemis limitata three-lined leaf roller, Paramyelois transitella navel orangeworm, Platynota idaeusalis tufted apple bud moth, Platynota stultana omnivorus leafroller, Thysanoptera, Thripidae, Enneothrips flavens, Frankliniella fasca tobacco thrips, Frankliniella intonsa European flower thrips, Frankliniella occidentalis western flower thrips, Frankliniella schultzei common blossom thrips, Frankliniella tritici eastern flower thrips, Megalurothrips sjostedti cowpea thrips, Megalurothrips usitatus bean blossom thrips, Scirthothrips citri citrus thrips, Scirthothrips dorsalis yellow tea thrips, chilli thrips, Sericothrips variabilis soybean thrips, Stenchaetothrips biformis oriental rice thrips, Thrips arizonensis cotton thrips, Thrips meridionalis peach thrips, Thrips palmi melon thrips, and Thrips tabaci onion thrips, common cotton thrips.

In some cyantraniliprole aspects of the disclosure, the compositions produced according to the disclosure are effective against Leptinotarsa decemlineata Colorado potato beetle, Oulema oryzae rice leaf beetle, Phyllotreta cruciiferae cabbage flea beetle, Phyllotreta striolata striped flea beetle, Psylliodes spp. flea beetles, Anthonomus eugenii pepper weevil, Conotrachelus nenuphar plum curculio, Lissorhoptrus oryzophilus rice water weevil, Meligethes aeneus pollen beetle, blossom beetle, Liromyza chinensis stone leek leafminer, Liromyza huidobrensis pea leafminer, Liriomyza sativae serpentine/vegetable leafminer, Liromyza trifolii American serpentine leafminer, Delia antiqua onion fly, Delia platura seedcorn maggot, Psila rosae carrot fly, Bactrocera dorsalis oriental fruit fly, Bactrocera oleae olive fly, Ceratitis capitata Mediterranean fruit fly, Rhagoletis indifferens western cherry fruit fly, Rhagoletis pomonella apple maggot, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis fabae black bean aphid, Aphis gossypii cotton aphid, melon aphid, Aphis pomi green apple aphid, Aphis spiraceola spirea aphid, Aulacorthum solani foxglove aphid, Brevicoryne brassicae cabbage aphid, Dysaphis plantaginea rosy apple aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Schizaphis graminum greenbug, Sitobion avenae English grain aphid, Toxoptera citricida brown citrus aphid, oriental citrus aphid, Empoasca vitis green frogfly, Idioscopus spp. mango leafhopper, Nilaparvata lugens rice brown planthopper, Aonidiella aurantii citrus scale, Euschistus spp. brown stinkbugs, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistis citrella citrus leafminer, Pieris brassicae cabbage butterfly, large white, Pieris rapae imported cabbage worm, cabbage white, Plutella xylostella diamondback moth, Chilo suppressalis Asiatic rice stemborer, Cnaphalocerus medinalis rice leaffolder, Leucinodes orbonalis brinjal fruit borer, Ostrinia furnicalis Asian corn borer, Ostrinia nubilalis European corn borer, Choristoneura rosaceana oblique-banded leafroller, Eupoecilia arnbiguella grape berry moth, Cydia pomonella codling moth, Grapholita molesta oriental fruit moth, Lobesia botrana grape vine moth, Frankliniella fusca tobacco thrips, Frankliniella intonsa European flower thrips, Frankliniella occidentalis western flower thrips, Scirthothrips citri citrus thrips, Scirthothrips dorsalis yellow tea thrips, chilli thrips, Thrips palmi melon thrips, and Thrips tabaci onion thrips, common cotton thrips.

In some cyantraniliprole aspects of the disclosure, the compositions produced according to the disclosure are effective against Conotrachelus nenuphar plum curculio, Liromyza huidobrensis pea leafminer, Liriomyza sativae serpentine/vegetable leafminer, Liromyza trifolii American serpentine leafminer, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis gossypii cotton aphid, melon aphid, Brevicoryne brassicae cabbage aphid, Dysaphis plantaginea rosy apple aphid, Myzus persicae green peach aphid, peach potato aphid, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Phyllocnistis citrella citrus leafminer, Plutella xylostella diamondback moth, Chilo suppressalis Asiatic rice stemborer, Cnaphalocerus medinalis rice leaffolder, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella occidentalis western flower thrips, Scirthothrips dorsalis yellow tea thrips, chilli thrips, Thrips palmi melon thrips, and Thrips tabaci onion thrips, common cotton thrips.

In chlorantraniliprole aspects of the disclosure, the compositions produced according to the disclosure are effective against: Coleoptera (Chrysomelida, Leptinotarsa decemlineata Colorado potato beetle, Curculionidae, Lissorhoptrus oryzophilus rice water weevil, Listronotus maculicollis annual bluegrass weevil, Oryzophagus oryzae nce water weevil, Sphenophorus spp. Billbug, Scarabaeidae Ataenius spretulus black turfgrass ataenius, Aphodius spp. scarab beetles, Cotinis nitida green June beetle, Cyclocephala spp. masked chafers, Exornala orientalis oriental beetle grub, Maladera castanea Asiatic garden beetle, Phyllophaga spp. June beetles, Popillia japonica Japanese beetle, and Rhizotrogus majalis European chafer); Diptera (Agromyzidae, Chromatomyia horticola garden pea leafminer, and Liriomyza spp. Leafmiiners); Hemiptera (Aleyrodidae, Bemisia spp. Whitely, Trialeurodes abutiloneus bandedwinged whitefly, Cicadellidae, and Typhlocyba pomaria white apple leafhopper); Isoptera (Rhinotermitidae, Heterotermes tenuis sugarcane termite, Termitidae, Microtermes obesi sugarcane termite, and Odontotermes obesus sugarcane termite); and Lepidoptera (Arctiidae, Estigmene acrea saltmarsh caterpillar, Crambidae, Achyra rantalis garden webworn, Desmia funeralis grape leaffolder, Ostrinia nubilalis European corn borer, Gelechiidae, Anarsia lineatella peach twig borer, Keiferia lycopersicella tomato pinworm, Phthorimaea operculella potato tuberwvorm, Tuta absoluta S. American tomato pinworm, Geometridae, Operophthera brumata winter moth, Gracilaridae, Phyllocnistis citrella citrus leafminer, Lithocolletis ringoniella apple leafminer, Phyllonorycter blancardella spotted tentiform leafniner, Lyonetidae, Leucoptera spp. (ie: malifoliella, coffeella) coffee leafminer, pear leaf blister moth, Noctuidae, Agrotis ipsilon black cutworm, Alabama argillacea cotton leafworm, Amphipyra pyramidoides humped green fruitworm, Anticarsia gemmatalis velvetbean caterpillar, Autographa gamma common silver Y moth, Barathra brassicae cabbage armyworm, Earias spp. (ie: huegeliana, insulana, vitella) rough, spiny, northern rough bollworm, Helicoverpa spp. (ie: anmigera, punctigera, zea) bollworms/budworms/fruitworms, Heliothis virescens tobacco budworm, Lithophane antennata green fruitworm, Mamestra brassicae cabbage moth, Orthosia hibisci green fraitworm, Phalaenoides glycinae grape vine moth, Phytometra acuta tomato semi-looper, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieridae, Pieris spp. (ie: brassica, rapae) large white, imported cabbageworm, Plutellidae, Plutella xylostella diamondback moth, Pyralidae, Amyelois transitella navel orangeworm, Chilo spp. (ie: infuscatellus, polychrysus, suppressalis) sugarcane/rice stem borers, Cnaphalocrocis medinalis rice leafroller, Crambus spp. sod webworm, Crocidolomia binotalis cabbage cluster caterpillar, Diaphania spp. (ie: hyalinata, nitidalis) melonworm, pickleworm, Diatraea saccharalis, Brazilian sugarcane borer, Elasmopalpus lignosellus lesser stalk borer, Evergestis rimosalis cross-stripped cabbageworm, Hedylepta indicata soybean leaffolder, Hellula spp. (ie: hydralis, undalis) cabbage centre—grub, cabbage webworm, Leucinodes orbonalis eggplant shoot and fruit borer, Maruca spp. pod borer, Neoleucinodes elegantalis tomato small borer, Scirpophaga spp. sugarcane/rice stem borer, Sesamia spp. (ie: inferens, nonagrioides) pink stem borer/corn stalk borer, Sphingidae, Manduca spp. (ie: quinquemaculata, sexta) tomato/tobacco hornworm, Tortricidae, Adoxophyes orana summer fruit tortrix, Argyrotaenia spp. (ie: pulchellana, velutinana) grape tortrix, redbanded leafroller, Bonagota cranaodes Brazilian apple leafroller, Carposina spp. (ie: niponensis, sasaki) peach fruit borer, peach fruit moth, Choristoneura rosaceana obliquebanded leafroller, Cryptophlebia leucotreta false codling moth, Cydia pomonella codling moth, Ecdytolopha aurantiana citrus borer, Endopiza vitana grape berry moth, Epiphyas postvittana light brown apple moth, Eupoecilia ambiguella European grape berry moth, Grapholita molesta oriental fruit moth, Lobesia botrana European grapevine moth, Pandemis spp. (ie: cerasana, heparana, barred fruit tree tortrix, limitata, pyrusana) apple brown tortrix, three-lined leafroller, apple pandemic, Platynota spp. (ie: idaeusalis, stultana) tufted apple bud moth, omnivorous leafroller, Zygaenidae, and Harrisina spp. (ie: americana, brillians) grapeleaf, western grapeleaf skeletonizer).

In some chlorantraniliprole aspects of the disclosure, the compositions produced according to the disclosure are effective against: Leptinotarsa decemlineata Colorado potato beetle, Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Phthorimaea operculella potato tuberworm, Tuta absoluta S. American tomato pinworm, Phyllocnistis citrella citrus leafminer, Phyllonorycter blancardella spotted tentiform leafminer, Leucoptera spp. (ie: malifoliella, coffeella) coffee leafminer, Agrotis ipsilon black cutworm, Alabama argillacea cotton leafworm, Anticarsia gemmatalis velvetbean caterpillar, Helicoverpa spp. (ie: armigera, punctigera, zea) bollworns/budxworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieris spp. (ie: brassica, rapae) large white, imported cabbageworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer. Leucinodes orbonalis eggplant shoot and fruit borer, Scirpophaga spp. sugarcane/rice stem borer, Sesamia spp. (ie: inferens, nonagrioides) pink stem borer/corn stalk borer, Carposina spp. (ie: niponensis, sasaki) peach fruit borer, peach fruit moth, Choristoneura rosaceana obliquebanded leafroller, Cydia pomonella codling moth, Eupoecilia ambiguella European grape berry moth, Grapholita molesta oriental fruit moth, and Lobesia botrana European grapevine moth.

In some chlorantraniliprole aspects of the disclosure, the compositions produced according to the disclosure are effective against: Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Tuta absoluta S. American tomato pinworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Scirpophaga spp. sugarcane/rice stem borer, Sesamia spp. (ie: inferens, nonagrioides) pink stem borer/corn stalk borer, Cydia pomonella codling moth, Grapholita molesta oriental fruit moth, and Lobesia botrana European grapevine moth.

Plants

The compositions produced according to the present disclosure are thus useful for protecting agronomic field crops other non-agronomic horticultural crops and plants from phytophagous invertebrate pests. This utility includes protecting crops and other plants (i.e. both agronomic and nonagronomic) that contain genetic material introduced by genetic engineering (i.e. transgenic) or modified by mutagenesis to provide advantageous traits. Examples of such traits include tolerance to herbicides, resistance to phytophagous pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits. Examples of plants containing traits provided by genetic engineering or mutagenesis include varieties of corn, cotton, soybean and potato expressing an insecticidal Bacillus thuringiensis toxin such as YIELD GARD®, KNOCKOUT®, STARLINK®, BOLLGARD®, NuCOTN® and NEWLEAF®, INVICTA RR2 PRO™, and herbicide-tolerant varieties of corn, cotton, soybean and rapeseed such as ROUNDUP READY®, LIBERTY LINK®, IMI®, STS® and CLEARFIELD®, as well as crops expressing N-acetyltransferase (GAT) to provide resistance to glyphosate herbicide, or crops containing the HRA gene providing resistance to herbicides inhibiting acetolactate synthase (ALS). The compositions produced according to the present disclosure may interact synergistically with traits introduced by genetic engineering or modified by mutagenesis, thus enhancing phenotypic expression or effectiveness of the traits or increasing the invertebrate pest control effectiveness of the present compounds and compositions. In particular, the compositions produced according to the present disclosure may interact synergistically with the phenotypic expression of proteins or other natural products toxic to invertebrate pests to provide greater-than-additive control of these pests, i.e. produce a combined effect greater than the sum of their separate effects.

Plants within the scope of the present disclosure include crops, vegetables, fruits, trees other than fruit trees, lawn, and other uses (flowers, biofuel plants and ornamental foliage). Crops include: corn, rice, wheat, barley, rye, oat, sorghum, cotton, soybean, peanut, buckwheat, beet, rapeseed, sunflower, sugar cane, tobacco, and others known in the art. Vegetables include: solanaceous vegetables (for example, eggplant, tomato, pimento, pepper and potato); cucurbitaceous vegetables (for example, cucumber, pumpkin, zucchini, water melon, and melon); cruciferous vegetables (for example, Japanese radish, white turnip, horseradish, kohlrabi, Chinese cabbage, cabbage, leaf mustard, broccoli, and cauliflower); asteraceous vegetables (for example, burdock, crown daisy, artichoke and lettuce); liliaceous vegetables (for example, green onion, onion, garlic and asparagus); ammiaceous vegetables (for example, carrot, parsley, celery and parsnip); chenopodiaceous vegetables (for example, spinach and Swiss chard); and lamiaceous vegetables (for example, Perilla frutescens, mint and basil). Fruits include: pomaceous fruits (for example, apple, pear, Japanese pear, Chinese quince and quince); stone fleshy fruits (for example, peach, plum, nectarine, Prunus mume, cherry fruit, apricot and prune); citrus fruits (for example, Citrus unshiu, orange, lemon, lime and grapefruit); nuts (for example, chestnut, walnuts, hazelnuts, almond, pistachio, cashew nuts and macadamia nuts); berry fruits (for example, blueberry, cranberry, blackberry, strawberry, and raspberry); grape; kaki; persimmon; olive; Japanese plum; banana; coffee; date palm; coconuts; and oil palm. Trees other than fruit trees include: tea; mulberry; and other trees (for example, ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, Taxus cuspidate, elm and Japanese horse chestnut), Sweet viburnum, Podocarpus macrophyllus, Japanese cedar, Japanese cypress, croton, Japanese spindletree, and Photinia glabra). Lawn uses include: sods (for example, Zoysia japonica, Zoysia matrella); bermudagrasses; bent grasses; festucae; ryegrasses. Flower uses include: rose, carnation, chrysanthemum, Eustoma, gypsophila, gerbera, marigold, salvia, petunia, verbena, tulip, aster, gentian, lily, pansy, cyclamen, orchid, lily of the valley, lavender, stock, ornamental cabbage, primula, poinsettia, gladiolus, cattleya, daisy, cymbidium and begonia. Bio-fuel plants include: jatropha, safflower, Camelina, switch grass, Miscanthus giganteus, Phalaris arundinacea, Arundo donax, kenaf, cassava, and willow.

Non-Agronomic Uses

Non-agronomic uses refer to invertebrate pest control in the areas other than fields of crop plants. Nonagronomic uses of the compositions produced according to the present disclosure include control of invertebrate pests in stored grains, beans and other foodstuffs, and in textiles such as clothing and carpets. Nonagronomic uses of the compositions produced according to the present disclosure also include invertebrate pest control in ornamental plants, forests, in yards, along roadsides and railroad rights of way, and on turf such as lawns, golf courses and pastures. Nonagronomic uses of the compositions produced according to the present disclosure also include invertebrate pest control in houses and other buildings which may be occupied by humans and/or companion, farm, ranch, zoo or other animals. Nonagronomic uses of the compositions produced according to the present disclosure also include the control of pests such as termites that can damage wood or other structural materials used in buildings.

Nonagronomic uses of the compositions produced according to the present disclosure also include protecting human and animal health by controlling invertebrate pests that are parasitic or transmit infectious diseases. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. Compositions produced according to the present disclosure are suitable for systemic and/or non-systemic control of infestation or infection by parasites on animals. Compositions produced according to the present disclosure are particularly suitable for combating external parasitic or disease transmitting pests. Compositions produced according to the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. By combating these parasites, fatalities and performance reduction (in terms of meat, milk, wool, skins, eggs, honey, etc.) are reduced, so that applying a composition of the present disclosure allows more economic and simple husbandry of animals.

Water is used as a medium. In one embodiment, water is present in an amount of at least about 30 wt %. In one embodiment, water is present in an amount of at least about 45 wt %.

A dispersant can disperse active ingredients in the formulation and prevent agglomeration after dispersal in water. The dispersant can be chosen from any dispersant known in the art.

In some aspects, the dispersant is selected from ethoxylated aliphatic alcohol phosphate esters, including Dextrol OC-180, Dextrol OC-70, Dextrol OC-50, Dextrol OC-15, Stepfac 8181k, Surform SC8216, and a naphthalene sulfonate derivative or a lignosulfonate derivative.

In some aspects, the dispersant may comprise at least one polymeric surfactant. Polymeric surfactants fall into several categories including, but not limited to, block copolymers, random copolymers, graft copolymer and star polymers. Polymeric surfactants can be nonionic or anionic. Non-limiting examples of block copolymers include Atlas™ G-5000 and Atlas™ G-5002L (butyl block copolymers). A non-limiting example of a graft copolymer is Atlox® 4913 (a methyl methacrylate graft copolymer backbone having PEG extending therefrom). A non-limiting example of a nonionic polymer is Break Thru® DA 647. A non-limiting example of an anionic polymer is modified styrene acrylic polymer (e.g. Metasperse™ 1550s) or salts of lignonsulfonates (e.g. Reax 88B or Borresperse NA).

In one embodiment, the dispersant is present in an amount in the range of about 0.1 wt % to about 15 wt %. In another embodiment, the dispersant is present in an amount in the range of about 1 wt % to about 10 wt %. In another embodiment, the dispersant is present in an amount in the range of about 0.5 wt % to about 5 wt %. In another embodiment, the dispersant is present in an amount in the range of about 0.5 wt % to about 3 wt %.

A wetting agent can aid in the milling process. In one embodiment, the wetting agent is selected from nonionic surfactants, anionic surfactants, cationic surfactants, zwitterionic surfactants, and combinations thereof. In one embodiment, the wetting agent is an alkyl polyglycoside, including Agnique PG 9116, Agnique PG 8107, Agnique PG 8105, and alkyl ethoxylates.

In one embodiment, the wetting agent is present in an amount in the range of about 0.01 wt % to about 6 wt %. In another embodiment, the wetting agent is present in an amount in the range of about 0.1 wt % to about 1 wt %.

Nonionic Surfactants

Non-limiting examples of nonionic surfactants include alkoxylates, fatty alcohol alkoxylates, siloxanes/silicones, alkylphenol alkoxylates, fatty acid alkoxylates, alkoxylated amines, alkoxylated fatty acid amides, terminally blocked alkoxylates, fatty acid esters of polyhydroxy compounds, fatty acid esters of glycerol, fatty acid esters of sorbitol, fatty acid esters of sucrose, alkylpolyglucosides, amine oxide, and combinations thereof. Alkoxy groups may suitably be ethoxy, propoxy, or a combination of ethoxy and propoxy groups in random or block configuration.

In more detail, non-limiting examples of nonionic surfactants include: alcohol alkoxylates (such as alcohol alkoxylates based on natural and synthetic alcohols (which may be branched or linear) and prepared from the alcohols and ethylene oxide, propylene oxide, butylene oxide or mixtures thereof); amine ethoxylates, alkanolamides and ethoxylated alkanolamides; alkoxylated triglycerides (such as ethoxylated soybean, castor and rapeseed oils); alkylphenol alkoxylates (e.g., octyl- (such as the Triton® X series), nonyl- (such as the Tergitol® HP series), dinonyl-, or dodecyl-)); ethoxylated fatty acids; ethoxylated fatty esters and oils (such as Break Thru® SP 133); ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers (such as block polymers prepared from ethylene oxide or propylene oxide and reverse block polymers where the terminal blocks are prepared from propylene oxide; ethoxylated fatty acids), alkyd PEG (polyethylene glycol) resins, alkyd type copolyesters, graft or comb polymers, and star polymers; polyethylene glycols (PEG); polyethylene glycol fatty acid esters; silicone-based surfactants; sugar-derivatives such as sucrose esters, alkyl polyglycosides and alkyl polysaccharides; and combinations thereof. In one embodiment, the nonionic surfactant is Agnique PG 9116.

In some aspects, the nonionic surfactant component comprises at least one nonionic surfactant selected from sorbitan fatty acid esters, polyethoxylated sorbitan fatty acid esters, sorbitol ethoxylate esters and combinations thereof. Non-limiting examples of sorbitan fatty acid esters include sorbitan monolaurates (e.g., Span™ 20), sorbitan monopalmitates (e.g., Span™ 40), sorbitan monostearates (e.g., Span™ 60), sorbitan tristearates (e.g., Span™ 65), sorbitan monooleates (e.g., Span™ 80), sorbitan trioleates (e.g., Span™ 85), and combinations thereof. Non-limiting examples of polyethoxylated sorbitan fatty acid esters include Tween® 20, Tween® 21, Tween® 40, Tween® 60, Tween® 80, and Surfonic® L24-4. Non-limiting examples of sorbitol ethoxylate esters that may be suitable for the biopesticides described herein include polyoxyethylene sorbitol oleates (e.g., Arlatone® TV), polyoxyethylene sorbitol hexaoleates (e.g., Cirrasol® G-1086), polyoxyethylene sorbitol hexaoleates (e.g., Cirrasol® G-1096), polyoxyethylene oleate-laurates (e.g., Atlox 1045AR®), and combinations thereof. Polyethoxylated sorbitan fatty acid esters and sorbitol ethoxylate esters having a degree of ethoxylation of 20, 30, 40, 50, 60, 70 or 80 are generally suitable.

In some aspects, the nonionic surfactant component may comprise at least one organosilicone surfactant. Non-limiting examples of organosilicone surfactants within the scope of the present disclosure include: polyether siloxanes (e.g., Break Thru® OE441); polyether trisiloxanes (e.g., Break Thru® S240, Break Thru® 5233); polyoxyethylene dimethylsiloxanes (e.g., Dyne-Amic® (a mixture with methylated seed oil)); polyoxyethylene methylpolysiloxanes (e.g., KF-640 manufactured by Shin-Etsu Chemical Co., Ltd.); polyalkylene oxide-modified polymethylsiloxane (e.g., Kinetic manufactured by Helena Chemical); polyoxyethylene propylheptamethyltrisiloxanes (e.g., Masil® SF19); polyether-modified polysiloxanes (e.g., Quark (a mixture with an alkyl phenol ethoxylate)); hydroxypropyl heptamethyltrisiloxanes (e.g., Silflow® (a mixture with ethoxylated acetate, polyethylene glycol monoallyl ether acetate and polyethylene glycol diacetate); polyalkylene oxide-modified heptamethyltrisiloxanes (e.g., Silwet® L77); polyether/polymethylsiloxane copolymers (e.g., Syl-Coat®); polyoxyethylene-modified polydimethylsiloxanes (e.g., Xiameter®); polyoxyalkylene oxypropylheptamethyltrisiloxanes; siloxane/polyalkylene oxide copolymers (e.g., Vestis™ (a mixture with polyalkylene oxide)). In some aspects, the nonionic surfactant the organosilicone surfactant is a polyether trisiloxane such as, for instance, Break Thru® S240 (a mixture of a polyether trisiloxane and an alcohol ethoxylate (CAS 9043-30-5)), Break Thru® S321, Break Thru® S200, Break Thru® OE 441, Break Thru S278, Break Thru® S243, Break Thru® S233, Silwet® L-77, Silwet® 408, Silwet® HS 429, Silwet® HS 312, Silwet Y-12808, Silwet® L-7607, Silwet® L-7602, Silwet® L-7210, Silwet® L-7002, Silwet® L-720, and Silwet® L-7200, Sylgard® 309, and Silibase® 2848, and combinations thereof. In some aspects, the organosilicone surfactant is Break Thru® S240. In some aspects, the organosilicone surfactant is Silwet® HS 312.

In some aspects, the nonionic surfactant component may comprise at least one alcohol alkoxylate surfactant, at least one alkylphenol alkoxylate surfactant, at least seed oil alkoxylate surfactant (e.g., Ecosurf® SA-4, Ecosurf® SA-7, Ecosurf® SA-9, and Ecosurf® SA-15), at least one alkylamine alkoxylate surfactant, at least one tallow amine alkoxylate surfactant, at last one fatty acid alkoxylate surfactant, and combinations thereof. In some aspects, the alkoxylates may be end capped. Alcohol alkoxylates generally comprise a hydrophobic alkyl chain attached by an ether linkage to a hydrophilic alkoxy chain and have the general formula R—(OC₂₋₄)ₙ—OH. R may be C₆₋₁₈ straight or branched chain alkyl. The alkoxy moiety (OC₂₋₄) may be ethoxy, n-propyl, i-propyl, n-butyl, i-butyl or tert-butyl. In some aspects, the alkoxy moiety may be a block co-polymer of a polymeric ethoxy and polymeric propoxy or polymeric butoxy, and n may suitably be an integer of from 2 to 100. Suitable alcohol alkoxylates include linear alcohol alkoxylates, branched alcohol alkoxylates, secondary alcohol alkoxylates, and mixtures thereof. Non-limiting examples of alcohol alkoxylates include: Plurafac® SL-42 (C₆₋₁₀—(PO)₃(EO)₆); Plurafac® SL-62 (C₆₋₁₀—(PO)₃(EO)₈); Lutensol® XL series of the general structure Guerbet C₁₀—(PO)ₐ(EO)_{b} including without limitation Lutensol® XL-40, Lutensol® XL-50, Lutensol® XL-60, Lutensol® XL-70, Lutensol® XL-79, Lutensol® XL-80, Lutensol® XL-89, Lutensol® XL-90, Lutensol® XL-99, Lutensol® XL-100, and Lutensol® XL-140; Lutensol® XP series of the general structure Guerbet C₁₀-(EO)ₐ, including without limitation Lutensol® XP-40, Lutensol® XP-50, Lutensol® XP-60, Lutensol® XP-70, Lutensol® XP-79, Lutensol® XP-80, Lutensol® XP-89, Lutensol® XP-90, Lutensol® XP-99, Lutensol® XP-100; Lutensol® ON series of the general structure oxo C₁₀-(EO)ₐ, including without limitation Lutensol® ON-30, Lutensol® ON-50, Lutensol® ON-60, Lutensol® ON-70, Lutensol® ON-80, Lutensol ON-110; Lutensol® AO series of the general structure oxo C_{13/5}-(EO)ₐ, including without limitation Lutensol® AO-3, Lutensol® AO-5, Lutensol® AO-7, Lutensol® AG-79, Lutensol® AO-8, Lutensol® AO-11; Lutensol® TO series of the general structure oxo C₁₃-(EO)ₐ, including without limitation Lutensol® TO-6, Lutensol® TO-65, Lutensol® TO-7, Lutensol® TO-79, Lutensol® TO-8, Lutensol® TO-89, Lutensol® TO-10, Lutensol® TO-109, Lutensol® TO-12, Lutensol® TO-129, Lutensol® TO-15, Lutensol® TO-20; Lutensol® TDA series of the general structure oxo C₁₁—C₁₄—C₁₃ rich (EO)ₐ, including without limitation Lutensol® TDA-6, Lutensol® TDA 8, Lutensol® TDA-9, Lutensol® TDA-10; Ecosurf® EH series of the general structure 2-ethyl hexyl (PG)ₘ(EG)ₙ including Ecosurf® EH-3, Ecosurf® EH-6, and Ecosurf© EH-9; Ecosurf® SA series including Ecosurf® SA-4 (C₆₋₁₂ (PO)₃₋₄(EO)₄), Ecosurf® SA-7 (C₆₋₁₂—(PO)₃₋₄(EO)₇, and Ecosurf® SA-9 (C₆₋₁₂—(PO)₃₋₄(EO)₉); Tergitol® 15-5-3, Tergitol® 15-5-5, Tergitol® 15-5-7, Tergitol® 15-5-9, Tergitol® 15-5-12, Tergitol® 15-S-15, Tergitol® 15-5-20, Tergitol® 15-5-30, and Tergitol® 15-S-40; Tergitol® L-61, Tergitol® L-62, Tergitol® L-64, Tergitol® L-81, and Tergitol® L-101; Tergitol® TMN-3, Tergitol® TMN-6, and Tergitol® TMN-10), and combinations thereof. In some aspects, the alcohol alkoxylate is Lutensol® TDA 6. In some aspects, the alcohol alkoxylate is Lutensol® TO 6. In some aspects, the alcohol alkoxylate is Lutensol® TO 8.

In some aspects, the nonionic surfactant component may comprise at least one polymeric surfactant. Polymeric surfactants fall into several categories including, but not limited to, block copolymers, random copolymers, graft copolymer and star polymers. Non-limiting examples of polymer monomeric units include ethylene oxide, propylene oxide, acrylic, styrene, methacrylic, hydroxystearate, and ester (e.g., alkyd). Examples include, without limitation, EO/PG block copolymers, acrylic/styrene copolymers, methacrylic copolymers, poly hydroxystearate derivatives, alkyd PEG resin derivatives, and combinations thereof. Non-limiting examples of block copolymers include Atlas™ G-5000 and Atlas™ G-5002L (butyl block copolymers). A non-limiting example of a graft copolymer is Atlox® 4913 (a methyl methacrylate graft copolymer backbone having PEG extending therefrom). In some aspects, the nonionic surfactant component comprises Atlox® 4913. In some aspects, the nonionic surfactant component comprises Atlas™ G-5000. In some aspects, the nonionic surfactant component comprises Atlox© 4913, Atlas™ G-5000 and Lutensol® TDA 6.

In one embodiment, the nonionic surfactant is present in an amount in the range of about 0.01 wt % to about 10 wt %. In another embodiment, the nonionic surfactant is present in an amount in the range of about 0.1 wt % to about 5 wt %. In another embodiment, the nonionic surfactant is present in an amount in the range of about 0.1 wt % to about 2 wt %. In another embodiment, the nonionic surfactant is present in an amount in the range of about 0.1 wt % to about 1 wt %.

Anionic Surfactant Component

The compositions produced according to the present disclosure may comprise one or more anionic surfactants. Non-limiting examples of anionic surfactants include: alkylaryl sulfonic acids and their salts; carboxylated alcohols; diphenyl sulfonate derivatives; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; salts of sulfates of alkoxylated alcohols; sulfonates of amines and amides such as N,N-alkyltaurates; sulfonates of benzene, cumene, toluene, xylene, and dodecyl and tridecylbenzenes; sulfonates of naphthalene and alkyl naphthalene; sulfonates of fractionated petroleum; sulfosuccinamates; sulfosuccinates and their derivatives such as dialkyl sulfosuccinate salts; and combinations thereof. Non-limiting examples of cationic counterions of the anionic surfactants in salt form may include, but are not limited to, alkali metal, alkaline-earth metal, ammonium, or (C₁₋₆) alkyl ammonium cation.

Non-limiting examples of anionic surfactants within the scope of the present disclosure include: ammonium lauryl sulfate; magnesium lauryl sulfate; sodium 2-ethyl-hexyl sulfate; sodium octyl sulfate; sodium oleyl sulfate; sodium tridecyl sulfate; triethanolamine lauryl sulfate; ammonium nonylphenol ether sulfate; ammonium monoxynol-4-sulfate sulfo succinamates; tetrasodium N-(1,2-dicarboxyethyl)-N-octadecylsulfo-succinamate; diamyl ester of sodium sulfosuccinic acid; dihexyl ester of sodium sulfosuccinic acid; dioctyl esters of sodium sulfosuccinic acid; dihexyl ester of sodium sulfosuccinic acid; dioctyl esters of sodium sulfosuccinic acid (Aerosol OT 75 PG); calcium naphthalene sulfonates (DAXAD® 19LCAD); sodium methyl oleyl taurate (Geropon® T-77); sodium dodecylbenzene sulfonate; N-oleyl N-methyl taurate; 1,4-dioctoxy-1,4-dioxo-butane-2-sulfonic acid; sodium lauryl sulphate; sodium lauryl ether sulfate (Steol CS-370); calcium dodecylbenzenesulfonate (Rhodacal® 60 BE and 70 B); isopropyl amine dodecylbenzenesulfonate (Bio-Soft® N-411); and sodium diisopropyl naphthalenesulfonate (Morwet® IP). In some aspects, the anionic surfactant is Aerosol OT 75 PG.

In some aspects of the present disclosure, the surfactant component can comprise a mixture of at least one nonionic surfactant and at least one anionic surfactant.

In one embodiment, the anionic surfactant is present in an amount in the range of about 0.01 wt % to about 15 wt %. In another embodiment, the nonionic surfactant is present in an amount in the range of about 0.1 wt % to about 2 wt %. In another embodiment, the nonionic surfactant is present in an amount in the range of about 0.1 wt % to about 1 wt %.

Other Surfactants

In some aspects of the disclosure, the surfactant component may optionally comprise at least one cationic surfactant. Non-limiting examples of cationic surfactants include: amides and ethoxylated amides; amines (such as N-alkyl propanediamines, tripropylenetriamines and dipropylenetetramines); ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; amine oxides such as alkyldimethylamine oxides and bis-(2-hydroxyethyl)-alkylamine oxides; and combinations thereof.

In some aspects of the disclosure, the surfactant component may optionally comprise at least one zwitterionic (ampholytic) surfactant. Non-limiting examples of Zwitterionic (amphoteric) surfactants include betaines, N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids, alkylaminoacetic acids containing a C₈₋₁₈ alkyl group, and combinations thereof.

The total surfactant content in the concentrate compositions produced according to the present disclosure may suitably be about 5 wt. %, about 10 wt. %, about 15 wt. %, about 20 wt. %, about 25 wt. %.

In aspects where the surfactant component comprises one or more nonionic surfactant and one or more anionic surfactants, the weight ratio of total nonionic surfactant to total anionic surfactant is suitably about 5:1, about 4:1, about 3.5:1, about 3.25:1, about 3:1, about 2.75:1, about 2.5:1, about 2.25:1, about 2:1, about 1.75:1, about 1.5:1, about 1.25:1, or about 1:1, and ranges constructed therefrom, such as from about 5:1 to about 1:1, from about 3.5:1 to about 1:1, from about 3.5:1 to about 1.5:1, from about 3.25:1 to about 1.75:1, from about 3:1 to about 1.75:1, from about 2.75:1 to about 1.75:1, or from about 2.75:1 to about 1.5:1. In such aspects, the total nonionic surfactant content in the concentrate compositions is suitably about 2 wt. %, about 5 wt. %, about 10 wt. %, about 12.5 wt. %, about 15 wt. %, about 17.5 wt. %, about 20 wt. %, about 22.5 wt. %, about 25 wt. %, about 30 wt. %, or about 35 wt. %, and ranges constructed therefrom, such as from about 2 wt. % to about 35 wt. %, from about 5 wt. % to about 30 wt. %, from about 10 wt. % to about 25 wt. %, from about 12.5 wt. % to about 20 wt. %, or from about 12.5 wt. % to about 17.5 wt. %. In such aspects, the total anionic surfactant content in the concentrate compositions is suitably about 0.1 wt %, about 0.2 wt %, about 0.3 wt %, about 0.4 wt %. about 0.5 wt %. about 0.75 wt %, about 1 wt %, about 1.5 wt %, about 2 wt. %, about 2.5 wt. %, about 5 wt. %, about 6 wt. %, about 7 wt. %, about 8 wt. %, about 9 wt. %, about 10 wt. %, about 12.5 wt. %, about 15 wt. %, about 20 wt. %, or about 25 wt. %, and ranges constructed therefrom, such as from about 2 wt. % to about 25 wt. %, from about 2.5 wt. % to about 20 wt. %, from about 2.5 wt. % to about 15 wt. %, from about 2.5 wt. % to about 10 wt. %, or from about 5 wt. % to about 10 wt. %.

Adjuvants

In some aspects, one or more adjuvants may be used. In some aspects, the one or more adjuvants are formulation aids. In some aspects, the adjuvant is selected from dispersants, surfactants, biocides, bactericides, antifoamers, antifreeze agents, rheology modifiers, viscosity-modifying agents, wetting agents, solvents, and combinations thereof.

An antifreeze agent can prevent the formulation from freezing. In one embodiment, the antifreeze agent is selected from propylene glycol, glycerol, urea, inorganic salts selected from ammonium, sodium, potassium, lithium salts of sulfate, nitrate, chloride, citrate, phosphate, polyphosphate, acetate, tartarate, and succinate, calcium, magnesium salts of nitrate, chloride, citrate, acetate, tartarate, succinate, and combinations thereof. In some aspects of the present disclosure, the antifreeze agent is propylene glycol. In some aspects of the present disclosure, the antifreeze agent is glycerol. In some aspects of the present disclosure, the antifreeze agent is ammonium sulfate. In some aspects of the present disclosure, the antifreeze agent is a mixture of glycerol and ammonium sulfate.

A biocide can prevent bacteria from growing. Suitable biocides include, but are not limited to bactericides such as Legend™ MK (mixture of 5-chloro-2methyl-3(2H)-isothiazolone with 2-methyl-3(2H)-isothiazolone), EDTA (ethylenediaminetetraacetic acid), formaldehyde, benzoic acid, or 1,2benzisothiazol-3(2H)-one or its salts, e.g., Proxel® BD or Proxel® GXL (Arch), Acticide LA 1209, Acticide SPX, Proxel CXL, KathonCG/ICP and KathonCG/ICPII. In one embodiment, the biocide is selected from 2-Bromo-2-nitropropane-1, 3-diol, 5-Chloro-2-methyl-2H-isothiazol-3-one, 2-Methyl-2H-isothiazol-3-one, and combinations thereof. In one embodiment, the biocide is Acticide LA 1209.

In one embodiment, the biocide is present in an amount in the range of about 0.01 wt % to about 2 wt %. In another embodiment, the biocide is present in an amount in the range of about 0.01 wt % to about 1 wt %. In another embodiment, the biocide is present in an amount in the range of about 0.01 wt % to about 0.5 wt %. In another embodiment, the biocide is present in an amount in the range of about 0.01 wt % to about 0.1 wt %.

Antifoanmers can prevent foaming during manufacturing and handling of the product. In one embodiment, the antifoamer is selected from silicone-based emulsions (e.g Xiameter AFE-0100, SAG 1572, Agnique DFM 111S, Break Thru AF 9903). In one embodiment, the antifoamer is Xiameter AFE-0100.

In one embodiment, the antifoamer is present in an amount in the range of about 0.01 wt % to about 2 wt %. In another embodiment, the antifoamer is present in an amount in the range of about 0.01 wt % to about 1 wt %. In another embodiment, the antifoamer is present in an amount in the range of about 0.01 wt % to about 0.5 wt %.

A rheology modifier can prevent settling and sedimentation. In one embodiment, the rheology modifier is a viscosity-modifying agent. In one embodiment, the rheology modifier is selected from hydrated magnesium aluminosilicate, xantham gum, amorphous silica, and combinations thereof. In one aspect, suitable commercially available rheology modifiers include, for example, Van Gel B, Veegum K, Veegum H S, Veegum T, Veegum Pure, Acti-gel 208, Rhodopol 23, Kelzan S, Kelzan S plus, Aerosil, AEROSIL® R 202, AEROSIL® R 805, AEROSIL® R 812 S, AEROSIL® R 816, AEROSIL® R 972, AEROSIL® R 974, AEROSIL® 200, AEROSIL® 300, AEROSIL® 380, and Bentonite (e.g Vanatural). In another aspect, suitable viscosity-modifying agents are sodium carboxymethylcellulose, hydroxyethyl cellulose, hydroxypropyl cellulose and hydroxypropylmethyl cellulose. In one embodiment, the rheology modifier is Kelzan S plus.

In one embodiment, the rheology modifier is present in an amount in the range of about 0.01 wt % to about 5 wt %. In another embodiment, the rheology modifier is present in an amount in the range of about 0.01 wt % to about 4 wt %. In another embodiment, the rheology modifier is present in an amount in the range of about 0.01 wt % to about 3 wt %. In another embodiment, the rheology modifier is present in an amount in the range of about 0.01 wt % to about 2 wt %. In another embodiment, the rheology modifier is present in an amount in the range of about 0.01 wt % to about 1 wt %. In another embodiment, the rheology modifier is present in an amount in the range of about 0.01 wt % to about 0.5 wt %. In another embodiment, the rheology modifier is present in an amount in the range of about 0.01 wt % to about 0.25 wt %. In another embodiment, the rheology modifier is present in an amount in the range of about 0.01 wt % to about 0.1 wt %.

All plants or any part of a plant can be treated in accordance with compositions produced according to the processes of the disclosure. The term “plants” as used herein is to be understood as all plants and plant populations such as, for example, desired and undesired wild plants or crop plants (including naturally occurring crop plants). Crop plants can be plants that can be obtained by conventional breeding and optimization methods or by biotechnological and genetic engineering methods or by combinations of these methods, including transgenic plants and including plant cultivars which can or cannot be protected by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, as well as roots, tubers and rhizomes. The plant parts also include harvested material, and vegetative and generative propagation material, for example cuttings, tubers, rhizomes, offshoots and seeds.

Treatment of the plants and plant parts with the compositions produced according to the processes of the present disclosure is carried out by direct contact with the plant or plant part, or by action on the plant's environment, habitat or storage space using customary treatment methods. For example, treatment as described herein can be by dipping, spraying, evaporating, atomizing, broadcasting, spreading-on, injecting and, in the case of propagation material—particularly in the case of seeds—by applying a layer of a coating comprising the composition, optionally with additional layers.

In one embodiment, the compositions produced according to the processes of the present disclosure are aerially delivered to plants. In another embodiment, the compositions produced according to the present disclosure are delivered by an unmanned aerial vehicle (UAV). In yet another embodiment, the compositions produced according to the present disclosure are delivered by a helicopter or fixed-wing airplane.

Wild plant species and plant cultivars, or those obtained by conventional biological breeding methods, such as crossing or protoplast fusion, and parts thereof, may be treated. Also, transgenic plants and plant cultivars obtained by genetic engineering methods, if appropriate in combination with conventional methods (Genetically Modified Organisms), and parts thereof are treated. Plants of the plant cultivars that are in each case commercially available or in use are treated according to the disclosure. Plant cultivars are to be understood as meaning plants having novel properties (“traits”) which have been obtained by conventional breeding, by mutagenesis or by recombinant DNA techniques. These can be cultivars, biotypes or genotypes.

The transgenic plants or plant cultivars (obtained by genetic engineering) that may be treated according to the disclosure include all plants which, by the genetic modification, received genetic material which imparted particular advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defense of the plants against animal and microbial pests, such as against insects, mites, phytopathogenic fungi, bacteria and/or viruses, and increased tolerance of the plants to certain herbicidally active compounds. Examples of transgenic plants include the important crop plants, such as cereals (wheat, rice), maize, soybeans, potatoes, sugar beet, tomatoes, peas and other vegetable varieties, cotton, tobacco, oilseed rape and fruit plants (with the fruits apples, pears, citrus fruits and grapes), and emphasis is given to maize, soybeans, potatoes, cotton, tobacco and oilseed rape. Traits include the increased defense of the plants against insects, arachnids, nematodes and slugs and snails by toxins formed in the plants, particularly those formed in the plants by the genetic material from Bacillus thuringiensis (for example by the genes CryIA(a), CryIA(b), CryIA(c), CryIIA, CryIIIA, Cry-IIIB2, Cry9c, Cry2Ab, Cry3Bb and CryIF and also combinations thereof) (“Bt plants”). Other traits are the increased defense of plants against fungi, bacteria and viruses by systemic acquired resistance (SAR), systemin, phytoalexins, elicitors and resistance genes and correspondingly expressed proteins and toxins. Traits also include the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” include maize varieties, cotton varieties, soybean varieties and potato varieties which are sold under the trade names YIELD GARD® (for example maize, cotton, soybeans), KnockOut® (for example maize), StarLink® (for example maize), Bollgard® (cotton), Nucotn® (cotton) and NewLeaf® (potato). Examples of herbicide-tolerant plants are maize varieties, cotton varieties and soybean varieties that are sold under the trade names Roundup Ready® (tolerance to glyphosate, for example maize, cotton, soybean). Liberty Link® (tolerance to phosphinotricin, for example oilseed rape), IMI® (tolerance to imidazolinones) and STS® (tolerance to sulfonylureas, for example maize). Herbicide-resistant plants (plants bred in a conventional manner for herbicide tolerance) include the varieties sold under the name Clearfield® (for example maize). The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

Depending on the plant species or plant cultivars, their location and growth conditions (soils, climate, vegetation period, diet), the treatment according to the disclosure may also result in superadditive (“synergistic”) effects. Thus, for example, reduced application rates and/or a widening of the activity spectrum and/or an increase in the activity of the substances and compositions which can be used according to the disclosure, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

Crops that can be protected with the compositions produced according to the processes of this disclosure, for example, comprise cereals (wheat, barley, rye, oats, rice, maize, sorghum, etc.), fruit trees (apples, pears, plums, peaches, almonds, cherries, bananas, grapes, strawberries, raspberries, blackberries, etc.), citrus trees (oranges, lemons, mandarins, grapefruit, etc.), legumes (beans, peas, lentils, soybean, etc.), vegetables (spinach, lettuce, asparagus, cabbage, carrots, onions, tomatoes, potatoes, eggplants, peppers, etc.), cucurbitaceae (pumpkins, zucchini, cucumbers, melons, watermelons, etc.), oleaginous plants (sunflower, rape, peanut, castor, coconut, etc.), tobacco, coffee, tea, cocoa, sugar beet, sugar cane, and cotton.

To protect the agricultural crops, the compositions produced according to the processes of this disclosure can be applied to any part of the plant, or on the seeds before sowing, or on the soil in which the plant grows.

The embodiments of this disclosure include:

Embodiment 1. A process of preparing an aqueous suspension of organic pesticides, the process comprising
I) forming a mixture comprising
A) a formulation additive; and
B) at least one crystalline organic pesticide;

II) adding at least one amorphous organic pesticide to the mixture under conditions of agitation or emulsification;

III) crystallizing the at least one amorphous organic pesticide;

IV) optionally filtering the mixture;

V) optionally drying the mixture; and

VI) optionally milling the mixture;

wherein the at least one amorphous organic pesticide is not identical to the at least one crystalline organic pesticide.

Embodiment 2. A process of preparing an aqueous suspension of organic pesticides, the process comprising

I) forming a mixture comprising a formulation additive;

II) adding at least one amorphous organic pesticide to the mixture under conditions of agitation or emulsification;

III) adding at least one crystalline organic pesticide to the mixture;

IV) crystallizing the at least one amorphous organic pesticide;

V) optionally filtering the mixture;

VI) optionally drying the mixture; and

VII) optionally milling the mixture;

wherein the at least one amorphous organic pesticide is not identical to the at least one crystalline organic pesticide.

Embodiment 3. The process of any of embodiments 1-2, wherein the formulation additive is selected from water, anti-freeze agents, viscosity-modifying agents, antifoams, bactericides, surfactants, and combinations thereof.

Embodiment 4. The process of any of embodiments 1-3, wherein the at least one amorphous organic pesticide has a melting point in the range of about 40° C. to about 80° C.

Embodiment 5. The process of any of embodiments 1-4, wherein the at least one amorphous organic pesticide has a melting point in the range of about 40° C. to about 70° C.

Embodiment 6. The process of any of embodiments 1-5, wherein the at least one amorphous organic pesticide has a solubility in water of less than about 2 mg/L at 20° C.

Embodiment 7. The process of any of embodiments 1-6, wherein the at least one amorphous organic pesticide has a solubility in water of less than about 10 μg/L at 20° C.

Embodiment 8. The process of any of embodiments 1-7, wherein the at least one amorphous organic pesticide is in a form selected from a melt, a supercooled melt, a solid amorphous form, a liquid, a solution comprising an active ingredient and a water miscible solvent, and combinations thereof.

Embodiment 9. The process of any of embodiments 1-8, wherein the at least one amorphous organic pesticide is selected from bifenthrin, gamma-cyhalothrin, lambda-cyhalothrin, pyraclostrobin, chlorpyrifos, and combinations thereof.

Embodiment 10. The process of any of embodiments 1-9, wherein the at least one crystalline organic pesticide has a melting point greater than about 60° C.

Embodiment 11. The process of any of embodiments 1-10, wherein the at least one crystalline organic pesticide has a melting point greater than about 80° C.

Embodiment 12. The process of any of embodiments 1-11, wherein the at least one crystalline organic pesticide has a solubility in water of less than 2 g/L at 20° C.

Embodiment 13. The process of any of embodiments 1-12, wherein the at least one crystalline organic pesticide has a solubility in water of less than 600 mg/L at 20° C.

Embodiment 14. The process of any of embodiments 1-13, wherein the at least one crystalline organic pesticide has a solubility in water of less than 150 mg/L at 20° C.

Embodiment 15. The process of any of embodiments 1-14, wherein the at least one crystalline organic pesticide is selected from insecticides, fingicides, nematicides, and combinations thereof.

Embodiment 16. The process of any of embodiments 1-14, wherein the at least one crystalline organic pesticide is selected from chlorantraniliprole, cyantraniliprole, flutriafol, indoxacarb, imidacloprid, fluindapyr and combinations thereof.

Embodiment 17. The process of any of embodiments 1-16, wherein the process step of milling the mixture occurs with a device selected from attritor mills, bead mills, colloid mills, rotor-stators, jet mills, air classifying mills, ring mills, hammer mills, pin mills, puck mills, and combinations thereof.

Embodiment 18. The process of any of embodiments 1-16, wherein the process step of milling the mixture occurs with a mill selected from ring mills, bead mills, attritor mills, jet mills, air classifying mills, and combinations thereof.

Embodiment 19. The process of any of embodiments 1-18, wherein the process step of adding at least one amorphous organic pesticide to the mixture occurs at a temperature in the range of about 20° C. to about 100° C.

Embodiment 20. The process of any of embodiments 1-19, wherein the process step of adding at least one amorphous organic pesticide to the mixture occurs at a temperature in the range of about 30° C. to about 65° C.

Embodiment 21. The process of any of embodiments 1-20, wherein the process step of crystallizing the at least one amorphous organic pesticide comprises

A) mixing the mixture; and

B) optionally cooling the mixture.

Embodiment 22. An aqueous suspension of organic pesticides produced according to any of embodiments 1-21.

Embodiment 23. A process of preparing an aqueous pesticide formulation, the process comprising adding an additive selected from water, anti-freeze agents, viscosity-modifying agents, antifoams, bactericides, surfactants, and combinations thereof to the aqueous suspension of organic pesticides produced according to any of embodiment 1-22.

Embodiment 24. An aqueous pesticide formulation produced according to embodiment 23.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

### Preparation Procedure 1. Adding a Pesticide to be Crystallized to a Formulation Containing a Seeding Pesticide

A slurry of a crystalline organic pesticide, such as a high melting insecticide, and at least one formulation aid (e.g. water or anti-freeze agents) at a temperature less than about 100° C., or at a temperature lower than the melting point of the crystalline organic pesticide, or at about room temperature, is charged with an amorphous organic pesticide, such as hot melted bifenthrin (at about 68 to 90° C.), or gamma-cyhalothrin (at about 50-70° C.), under homogenization. The slurry temperature increases to above 30° C. due to the amorphous organic pesticide, and then the slurry is cooled, either naturally under agitation or optionally with applied cooling, until the amorphous organic pesticide crystallizes. The mixed crystalline solid is then milled to a desired particle size. The formulation is finalized by adding a viscosity-modifying agent.

### Preparation Procedure 2. Adding a Seeding Pesticide to a Formulation Containing a Pesticide to be Crystallized

A formulation aid (e.g. water or at least one anti-freeze agent) at a temperature less than about 100° C., or at a temperature lower than the melting point of a crystalline organic pesticide, such as a high melting insecticide, or at about room temperature, is charged to a mix vessel equipped with a cooling system and homogenizer and agitated until well mixed. An amorphous organic pesticide, such as melt bifenthrin technical (70 to 90° C.) or gamma-cyhalothrin (about 50-70° C.), is fed to the vessel under homogenization. The crystalline organic pesticide is charged as a seed to induce crystallization of the amorphous organic pesticide. The mixed crystalline solid is then milled to a desired particle size. The formulation is finalized by adding a viscosity-modifying agent.

### Example 1. Preparation of a Bifenthrin and Chlorantraniliprole Formulation According to Preparation Procedure 1

A slurry of chlorantraniliprole with Dextrol OC-180, Agnique P09116, Atlox 4913, Xiameter AFE-0100, and water was formed. Under agitation, the slurry was heated to 80° C. Melted bifenthrin was added. Heating was removed and the slurry was cooled to room temperature over about two hours, and bifenthrin crystallized out. Cooling was applied until an internal temperature of about 20° C. was achieved. The mixture was held for about one hour and then milled.

### Example 2. The Bifenthrin and Chlorantraniliprole Formulation Prepared in Example 1

TABLE 1
Bifenthrin and chlorantraniliprole formulation.

| | w/w |
|---|---|
| Ingredients | (%) |
| Waxy Bifenthrin technical | 14.6 |
| Chlorantraniliprole Technical | 9.8 |
| Dextrol OC-180 | 2.0 |
| Agnique PG9116 | 2.0 |
| Atlox 4913 | 3.0 |
| Xiameter AFE-0100 | 0.17 |
| Water | 47.0 |
| Kelzan S+ 2% | 7.4 |
| Acticide LA 1209 | 0.1 |
| Glycerin | 5.0 |
| Ammonium sulfate | 3.1 |
| Agnique PG9116 | 4.0 |
| Water | 1.8 |
| Total | 100 |

### Example 3. Preparation of a Bifenthrin and Chlorantraniliprole Formulation According to Preparation Procedure 2

Waxy bifenthrin was melted in an 80° C. oven, and was added to an aqueous solution contain formulation aids while mixing vigorously. Then chlorantraniliprole technical was added. The mixture was stirred overnight to complete the crystallization of bifenthrin. The slurry was added to a large Eiger mill and milled to a desired particle size (d90<10 μm). Prehydrated Kelzan S plus was added as a suspension aid.

### Example 4. The Bifenthrin and Chlorantraniliprole Formulation Prepared in Example 3

TABLE 2
Bifenthrin and chlorantraniliprole formulation.

| | w/w |
|---|---|
| Ingredients | (%) |
| Crystalline Bifenthrin technical | 14.6 |
| solid | |
| Chlorantraniliprole Technical | 9.8 |
| Dextrol OC-180 | 2.0 |
| Agnique PG9116 | 6.0 |
| Atlox 4913 | 3.0 |
| Xiameter AFE-0100 | 0.2 |
| Kelzan S+ 2% | 7.4 |
| Acticide LA 1209 | 0.1 |
| Glycerin | 5.0 |
| Ammonium sulfate | 3.1 |
| Water | 48.8 |
| Total | 100.0 |

### Example 5. Bifenthrin and Cyantraniliprole Formulation Prepared According to Preparation Procedure 1

TABLE 3
Bifenthrin and cyantraniliprole formulation.

| | w/w |
|---|---|
| Ingredients | (%) |
| Waxy Bifenthrin technical, | 16.5 |
| 96.8% | |
| Cyantraniliprole Technical, | 8.3 |
| 96.7% | |
| Dextrol OC-180 | 2.0 |
| Agnique PG9116 | 1.2 |
| Atlox 4913 | 1.7 |
| Xiameter AFE-0100 | 0.2 |
| Kelzan S+ 2% | 11.0 |
| Acticide LA 1209 | 0.1 |
| Glycerin | 6.0 |
| Ammonium sulfate | 3.0 |
| Water | 50.0 |
| Total | 100.0 |

### Example 6. Bifenthrin and Flutriafol Formulation Prepared According to Preparation Procedure 2

TABLE 4
Bifenthrin and flutriafol formulation.

| | w/w |
|---|---|
| Ingredients | (%) |
| Waxy Bifenthrin technical, | 19.7 |
| 96.8% | |
| Flutriafol, 95.6% | 9.2 |
| Dextrol OC-180 | 2.2 |
| Agnique PG9116 | 1.3 |
| Atlox 4913 | 1.8 |
| Xiameter AFE-0100 | 0.2 |
| Kelzan S+ 2% | 11.1 |
| Acticide LA 1209 | 0.1 |
| Glycerin | 6.7 |
| Ammonium sulfate | 3.3 |
| Water | 44.3 |
| Total | 100.0 |

### Example 7. Bifenthrin and Chlorantraniliprole Formulation Prepared According to Preparation Procedure 1

TABLE 5
Bifenthrin and chlorantraniliprole formulation.

| | w/w |
|---|---|
| Ingredients | (%) |
| Waxy Bifenthrin technical | 20.9 |
| Chlorantraniliprole Technical | 5.2 |
| Dextrol OC-180 | 2.1 |
| Agnique PG9116 | 1.0 |
| Atlox 4913 | 1.8 |
| Xiameter AFE-0100 | 0.1 |
| Kelzan S+ 2% | 11.5 |
| Acticide LA 1209 | 0.1 |
| Glycerin | 6.3 |
| Ammonium sulfate | 3.1 |
| Water | 48.0 |
| Total | 100.0 |

### Example 8. Gamma-Cyhalothrin and Chlorantraniliprole Formulation Prepared According to Preparation Procedure 1

TABLE 6
Gamma-cyhalothrin and chlorantraniliprole formulation.

| | w/w |
|---|---|
| Ingredients | (%) |
| waxy Gamma-Cyhalothrin, | 4.3 |
| 95% | |
| Chlorantraniliprole Technical, | 16.7 |
| 97.6% | |
| Dextrol OC-180 | 2.0 |
| Agnique PG9116 | 0.8 |
| Atlox 4913 | 1.4 |
| Xiameter AFE-0100 | 0.2 |
| Kelzan S+ 2% | 10.0 |
| Acticide LA 1209 | 0.1 |
| Glycerin | 5.0 |
| Ammonium sulfate | 3.0 |
| Water | 56.6 |
| Total | 100.0 |

### Example 9. Bifenthrin and Indoxacarb Formulation Prepared According to Preparation Procedure 2

TABLE 7
Bifenthrin and indoxacarb formulation.

| | w/w |
|---|---|
| Ingredients | (%) |
| Waxy bifenthrin technical, | 18.5 |
| 96.8% | |
| indoxacarb, 95% | 9.4 |
| Dextrol OC-180 | 2.1 |
| Agnique PG9116 | 1.3 |
| Atlox 4913 | 1.7 |
| Xiameter AFE-0100 | 0.2 |
| Kelzan S+ 2% | 10.4 |
| Acticide LA 1209 | 0.1 |
| Glycerin | 6.3 |
| Ammonium sulfate | 3.1 |
| Water | 47.0 |
| Total | 100.0 |

### Example 10. Bifenthrin and Imidacloprid Formulation Prepared According to Preparation Procedure 2

TABLE 8
Bifenthrin and imidacloprid formulation.

| | w/w |
|---|---|
| Ingredients | (%) |
| Waxy Bifenthrin technical, | 18.5 |
| 96.8% | |
| imidacloprid, 98% | 9.4 |
| Dextrol OC-180 | 2.1 |
| Agnique PG9116 | 1.3 |
| Atlox 4913 | 1.7 |
| Xiameter AFE-0100 | 0.2 |
| Kelzan S+ 2% | 10.4 |
| Acticide LA 1209 | 0.1 |
| Glycerin | 6.3 |
| Ammonium sulfate | 3.1 |
| Water | 47.0 |
| Total | 100.0 |

### Example 11. Physical Properties of Formulations Prepared According to the Processes of the Present Disclosure

TABLE 9
Physical properties of prepared suspension concentration
formulations based on CIPAC methods.

| | Sus- | Wet | Par- | | Vis- | | |
|---|---|---|---|---|---|---|---|
| | pensibility | sieve, | ticle | | cosity, | | Per- |
| | (gravi- | 200 | size, | | 5 | Den- | sistent |
| | metric) | mesh | d50 | pH | RPM | sity | foaming |
| Example 5 | 99 | 0 | 0.16 | 4.65 | 2100 | 1.20 | 4 |
| Example 6 | 99 | 0.004 | 0.16 | 4.95 | 2300 | 1.12 | 4 |
| Example 7 | 99 | 0.07 | 0.16 | 4.52 | 3860 | 1.14 | 0 |
| Example 8 | 99 | 0 | 0.3 | 4.30 | 1800 | 1.14 | 2 |
| Example 9 | 99 | 0.05 | 0.16 | 4.89 | 2460 | 1.12 | 2 |
| Example | 99 | 0 | 0.13 | 4.7 | 2600 | 1.13 | 4 |
| 10 | | | | | | | |

This written description uses examples to illustrate the present disclosure, including the best mode, and also to enable any person skilled in the art to practice the disclosure. including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A process of preparing an aqueous suspension of organic pesticides, the process comprising
I) forming a mixture comprising
A) a formulation additive; and
B) at least one crystalline organic pesticide;
II) adding at least one amorphous organic pesticide to the mixture under conditions of agitation or emulsification;
III) crystallizing the at least one amorphous organic pesticide;
IV) optionally filtering the mixture;
V) optionally drying the mixture; and
VI) optionally milling the mixture;
wherein the at least one amorphous organic pesticide is not identical to the at least one crystalline organic pesticide.

2. A process of preparing an aqueous suspension of organic pesticides, the process comprising
I) forming a mixture comprising a formulation additive;
II) adding at least one amorphous organic pesticide to the mixture under conditions of agitation or emulsification;
III) adding at least one crystalline organic pesticide to the mixture;
IV) crystallizing the at least one amorphous organic pesticide;
V) optionally filtering the mixture;
VI) optionally drying the mixture; and
VII) optionally milling the mixture;
wherein the at least one amorphous organic pesticide is not identical to the at least one crystalline organic pesticide.

3. The process of any of claims 1-2, wherein the formulation additive is selected from water, anti-freeze agents, viscosity-modifying agents, antifoams, bactericides, surfactants, and combinations thereof.

4. The process of any of claims 1-3, wherein the at least one amorphous organic pesticide has a melting point in the range of about 40° C. to about 80° C.

5. The process of any of claims 1-5, wherein the at least one amorphous organic pesticide has a solubility in water of less than about 2 mg/L at 20° C.

6. The process of any of claims 1-4, wherein the at least one amorphous organic pesticide has a solubility in water of less than about 10 μg, at 20° C.

7. The process of any of claims 1-6, Wherein the at least one amorphous organic pesticide is in a form selected from a melt, a supercooled melt, a solid amorphous form, a liquid, a solution comprising an active ingredient and a water miscible solvent, and combinations thereof.

8. The process of any of claims 1-7, wherein the at least one amorphous organic pesticide is selected from bifenthrin, gamma-cyhalothrin, lambda-cyhalothrin, pyraclostrobin, chlorpyrifos, and combinations thereof.

9. The process of any of claims 1-8, wherein the at least one crystalline organic pesticide has a melting point greater than about 60° C.

10. The process of any of claims 1-9, Wherein the at least one crystalline organic pesticide has a solubility in water of less than 2 g/L, at 20° C.

11. The process of any of claims 1-9, wherein the at least one crystalline organic pesticide has a solubility in water of less than 600 mg/L at 20° C.

12. The process of any of claims 1-11, wherein the at least one crystalline organic pesticide is selected from insecticides, fungicides, nematicides, and combinations thereof.

13. The process of any of claims 1-11, wherein the at least one crystalline organic pesticide is selected from chlorantraniliprole, cyantraniliprole, flutriafol, indoxacarb, imidacloprid, fluindapyr and combinations thereof.

14. The process of any of claims 1-13, wherein the process step of milling the mixture occurs with a device selected from attritor mills, bead mills, colloid mills, rotor-stators, jet mills, air classifying mills, ring mills, hammer mills, pin mills, puck mills, and combinations thereof.

15. The process of any of claims 1-14, wherein the process step of adding at least one amorphous organic pesticide to the mixture occurs at a temperature in the range of about 20° C. to about 100° C.

16. The process of any of claims 1-15, wherein the process step of adding at least one amorphous organic pesticide to the mixture occurs at a temperature in the range of about 30° C. to about 65° C.

17. The process of any of claims 1-6, wherein the process step of crystallizing the at least one amorphous organic pesticide comprises
A) mixing the mixture; and
B) optionally cooling the mixture.

18. An aqueous suspension of organic pesticides produced according to any of claims 1-17.

19. A process of preparing an aqueous pesticide formulation, the process comprising adding an additive selected from water, anti-freeze agents, viscosity-modifying agents, antifoams, bactericides, surfactants, and combinations thereof to the aqueous suspension of organic pesticides produced according to any of claim 1-18.

20. An aqueous pesticide formulation produced according to claim 19.
